(19) United States
(12) Patent Application Publication
(10) Pub. No.: US 2001/0044908 A1
(43) Pub. Date: Nov. 22, 2001

(54) Stylus operated switch system for a portable data processing device

(76) Inventor: Wai Ho Siu, Thornhill (CA)

Correspondence Address: DAVID W. WONG, 46 Willowbrook Road, Thornhill, ON, L3T4W9, CA

(21) Appl. No.: 09/859,620

(22) Filed: May 18, 2001

Related U.S. Application Data
(60) Provisional application No. 60/204,749, filed on May 17, 2000.

(51) Int. Cl. G06F 1/26; G06F 1/28; G06F 1/30

(52) U.S. Cl. 713/323

(57) ABSTRACT

An automatic switching system is provided in a portable computing device having a stylus for entering information through the display screen of the device. The stylus is normally removably mounted in a fully inserted position in a channel of a mounting block located in the enclosure of the device. An interlock switch is mounted on a control electronic circuit board in the enclosure and located juxtaposed to the channel. The interlock switch has a push button extending into the channel and is operative by the stylus for turning the electrical power of the device on when the stylus is removed from the device.

### FIELD OF THE INVENTION

This invention relates to an automatic switch system for a portable data processing device operative with a stylus, and more particularly relates to an automatic power switch system for a hand-held computing device operated with a stylus.

### BACKGROUND OF THE INVENTION

Portable data processing devices such as compact hand-held devices commonly referred to as PDA (Personal Digital Assistant) devices or hand-held computers are often operated with a pen-like stylus which may be used to actuate menu items shown on a display screen of the device by touching the various icons appearing on the screen. The stylus may also be used for inputting information to the device by writing or drawing on the display screen directly. Such device commonly is provided with a power switch for turning its electrical power on or off. The power supply is usually provided by batteries.

The microprocessor in such device consumes a relatively large amount of power, and if the power of the device is left on for a lengthy time period, the batteries will invariably become depleted. Therefore, it is essential that the power must be turned off when the device is not being used in order to preserve the power supply. It has been problematic for the users of such device, that the power is inadvertently left on after use, so that the device becomes inoperative when it is required due to the depletion of the battery power.

Furthermore, since the stylus is not physically integral with the device, it often easily and inadvertently be misplaced; thus rendering the device inoperative without it.

### SUMMARY OF THE INVENTION

It is a principal object of the present invention to provide an automatic switch system operative with the stylus thus making the stylus an integral part of the device.

It is another object of the present invention to provide an automatic switch system which also provides a storage for the stylus when it is not in use.

It is another object of the present invention to provide an automatic switch system which turns the power of the device ON when the stylus is removed from its storage position for operating the device; and will also turn the power OFF when the stylus is replaced in the storage position.

Briefly, the automatic switching system comprises of a channel formed in the enclosure of the device. The channel is adapted for removably storing the stylus in a storage position located juxtaposed to an electronic circuit board of the device. An interlock switch is mounted on the circuit board. This switch has an operating push button extending into the channel and is operative by the stylus for turning the electrical power of the device ON when the stylus is removed from the device for inputting information through its LCD display screen.

### BRIEF DESCRIPTION OF THE DRAWINGS

Other objects and advantages of the present invention will become apparent from the following detailed description of the preferred embodiments thereof in connection with the accompanying drawings, in which

FIG. 1 is a perspective front elevation view of the portable data processing device operative with a stylus.

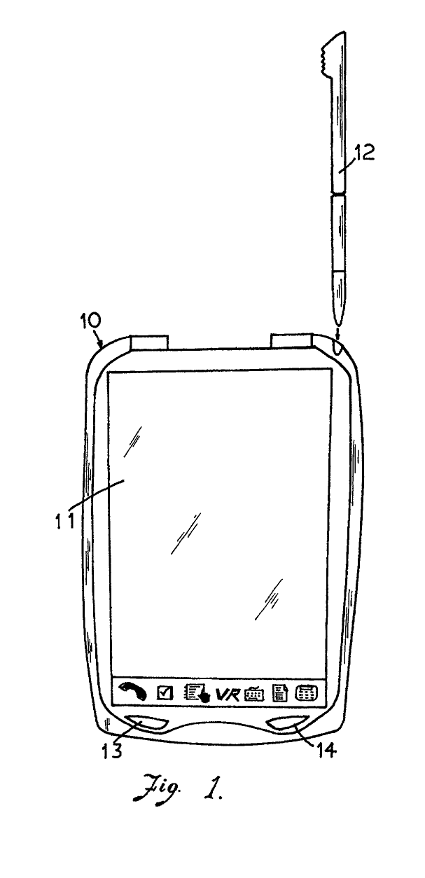

FIG. 2 is a perspective rear elevation view of the device with the rear cover therein removed showing the stylus storage channel and the interlock switch.

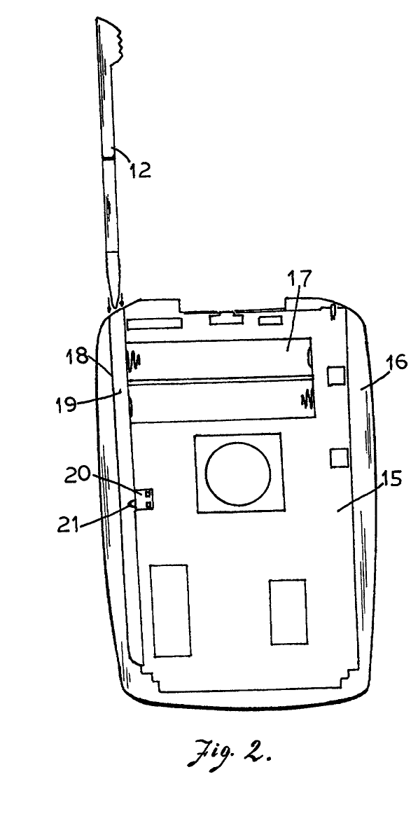

### DETAILED DESCRIPTION OF THE PREFERRED EMBODIMENTS

With reference to the drawings wherein like reference numerals designate corresponding parts in the several views, the portable hand-held data processing device 10 has a front display screen 11 usually made of an LCD display. The device 10 may be operated by touching various function icons showing on the display screen 11 with a pen-like stylus 12. Information may also be inputted to the device by writing or drawing directly on the display screen 11 with the stylus 12. Push button switches 13 and 14 may also be provided at the front to actuate various functions. The electrical components of the device are provided on a printed circuit board 15 mounted in the enclosure 16. A battery chamber 17 is provided in the enclosure 16 for housing the batteries.

A mounting block 18 is provided in the enclosure and positioned juxtaposed to one side of the printed circuit board 15. An elongated channel 19 is formed in the mounting block 18 and is adapted for the stylus 12 to be removably inserted therein in the storage position. An interlock switch 20 is mounted on the printed circuit board 15 and is located adjacent to the channel 19. The interlock switch 20 has an operating push button 21 extending into the channel 19 such that it will be operated by the stylus when the latter is inserted into the channel 19.

The interlock switch 20 is electrically connected to a control circuit provided in the printed circuit board 15, which operates to turn the power of the device 10 ON or OFF when the push button 21 of the interlock switch 20 is operated in an alternate sequence. Thus, when the stylus 12 is located in the storage position when it is fully inserted into the channel 19, the power of the device 10 will be automatically turned OFF. When the stylus 12 is removed for operating the device, the power of the device will be automatically turned ON. Thus, the system not only provides a storage for the stylus 12 but also provides an automatic switch system for turning the power of the device OFF when the stylus 12 is replaced into the storage position.

While the preferred embodiments of the invention have been described above. It will be recognized and understood that various modifications may be made therein and the appended claims are intended to cover all such modifications which may fall within the spirit and scope of the invention.

What is claimed is:

1. In a portable data processing device operative with a stylus, an automatic switching system comprising
a channel formed in an enclosure of said data processing device, said channel being adapted for removably storing said stylus in a storage position located juxtaposed to an electronic circuit board of said device,
an interlock switch mounted on said circuit board, said switch having an operating push button extending into said channel and being operative by said stylus for turning electrical power of said device ON when said stylus is removed from said device.

2. An automatic switch system according to claim 1 wherein said channel is formed in a mounting block located in said enclosure.

3. An automatic switch system according to claim 2 wherein said interlock switch is electrically connected in parallel with a power switch of said device.

4. An automatic switch system for a portable data processing device having an operating stylus for inputting data on a display screen of said device, comprising
an enclosure for housing an electronic circuit board and a stylus mounting block of said device,
a channel formed in said stylus mounting block and adapted for said stylus to be removably inserted in said channel,
an interlock switch mounted on said electronic circuit board and located juxaposed to said channel, said interlock switch being electrically connected to an electrical control circuit provided on said circuit board,
said interlock switch having a spring biassed operating push button extending into said channel, and being operative by said stylus for turning electrical power supply of said device off when said stylus is fully inserted into said channel in a mounted position, and for automatically turning electrical power supply of said device on when said stylus is removed from said channel.

5. An automatic switch system for a portable hand-held computing device having an operating stylus adapted for inputting data to said device by touching a display screen therein, comprising
an enclosure for housing an electronic circuit board of said device and a stylus mounting block,
a channel formed in said stylus mounting block,
an interlock switch mounted on said electronic circuit board an located juxtaposed to said channel, said interlock switch having an operating push button extending transversely into said channel, and adapted to be operated by said stylus when said stylus is removably mounted in said channel,
electrical control circuit provided on said electronic circuit board and being electrically connected to said interlock switch and being operative for turning power supply of said device on and off in an alternate sequence when said stylus is first removed from said channel and then re-inserted thereafter
